(19) United States
(12) Patent Application Publication
(10) Pub. No.: US 2017/0341083 A1
(43) Pub. Date: Nov. 30, 2017

(54) GRINDER WITH ENHANCED COOLING

(71) Applicant: BLUE SKY INNOVATION GROUP, INC., Avon, OH (US)

(72) Inventor: Jeffrey W. Palese, North Ridgeville, OH (US)

(21) Appl. No.: 15/164,989

(22) Filed: May 26, 2016

(51) Int. Cl. B02C 18/30

(52) U.S. Cl. CPC B02C 18/302; B02C 2018/307

(57) ABSTRACT

A meat grinder includes a motor including a stator and a rotor including a motor shaft, a transfer case operatively coupled to the motor shaft, and a grinder head operatively coupled to the transfer case. The grinder head includes an inlet into which a raw meat product can be fed and an outlet through which ground meat can be discharged. Rotation of the motor shaft imparts operation of the grinder head via the transfer case. The motor also includes a housing comprising a generally cylindrical outer wall that is spaced from the stator thereby creating a cooling channel between the stator and the outer wall. The housing further includes a front wall including a plurality of inlet openings and a rear wall including a plurality of outlet openings. The motor also includes a heat sink inside the housing positioned in the cooling channel adjacent the motor stator. The motor further includes a cooling fan coupled to the motor shaft and positioned adjacent the rear wall. During operation of the meat grinder, the motor rotates the cooling fan which discharges air from the housing through the outlet openings, which draws air into the housing through the inlet openings, creating air flow through the cooling channel, the air flow through the channel drawing heat from the heat sink prior to being discharged through the outlet openings.

### TECHNICAL FIELD

This invention relates to a food processing apparatus. More specifically, this invention relates to a grinder with enhanced cooling features.

### BACKGROUND OF THE INVENTION

Grinders are food processing appliances that are used to grind, chop or mince food products, such as meat, fish, poultry, vegetables, or similar foods. The most common food products processed in a grinder are meat products, such as beef, pork, venison, etc. Typical grinders include a drive unit to which a grinder head is detachably connected. The drive unit includes an electric motor that is operable to impart rotation to a shaft, which rotates an auger and one or more grinder blades. Raw cubed meat is fed into the grinder head. The auger moves the meat toward the grinder blades, which mince the meat. The ground meat is then forced through a die plate and discharged through an outlet.

During operation, the temperature inside the grinder head increases due to friction in the components and with the food products being processed. This heat can be enhanced due to the convection and/or conduction of heat that is generated by operation of the electric motor of the drive unit. When grinding meat, this increased temperature inside the grinder head can cause the meat to heat up stick to the grinder components, which can slow down, bind up, or block the grinding operation. Therefore, any degree to which the temperature of the grinder head and the components thereof can be reduced is highly desirable.

### SUMMARY

According to one aspect, a meat grinder includes a motor including a stator and a rotor including a motor shaft, a transfer case operatively coupled to the motor shaft, and a grinder head operatively coupled to the transfer case. The grinder head includes an inlet into which a raw meat product can be fed and an outlet through which ground meat can be discharged. Rotation of the motor shaft imparts operation of the grinder head via the transfer case. The motor also includes a housing comprising a generally cylindrical outer wall that is spaced from the stator thereby creating a cooling channel between the stator and the outer wall. The housing further includes a front wall including a plurality of inlet openings and a rear wall including a plurality of outlet openings. The motor also includes a heat sink inside the housing positioned in the cooling channel adjacent the motor stator. The motor further includes a cooling fan coupled to the motor shaft and positioned adjacent the rear wall. During operation of the meat grinder, the motor rotates the cooling fan which discharges air from the housing through the outlet openings, which draws air into the housing through the inlet openings, creating air flow through the cooling channel, the air flow through the channel drawing heat from the heat sink prior to being discharged through the outlet openings.

According to another aspect, the outer wall of the housing can be sized to extend outward beyond an outward extent of a housing of the transfer case so that air drawn into the cooling channel also causes air to flow over the outside of the transfer case housing. The air flowing over the outside of the transfer case housing draws heat from the transfer case.

According to another aspect, the heat sink can include a plurality of fins that extend parallel to each other along the length of the cooling channel. The heat sink can be positioned in contact with the motor stator so as to draw heat from the motor stator during operation of the motor.

According to another aspect, the grinder head can include an auger rotatable to move the raw meat from the inlet toward the outlet, a knife rotatable with the auger to grind the meat moved by the auger, and a fixed hole plate in the outlet through which the ground meat passes. The transfer case can include a housing including an output portion adapted to receive and support the grinder head, a coupling for receiving the auger, and reduction gears adapted to translate rotational force imparted by the motor shaft to rotation of the coupling and the auger.

According to another aspect, the meat grinder can also include a cooling unit attachable to the grinder head to cool the grinder head. The air drawn into the cooling channel can be at least partially cooled by flowing over the cooling unit prior to entering the cooling channel.

According to another aspect, a meat grinder can include a grinder head including an inlet into which a raw meat product can be fed and an outlet through which ground meat can be discharged, and a motor including a stator and a rotor including a motor shaft. The grinder head is operatively coupled to the motor shaft such that rotation of the motor rotor imparts grinding operation of the grinder head. The motor also includes a housing including a generally cylindrical outer wall that is spaced from the stator thereby creating a cooling channel between the stator and the outer wall. The motor also includes a heat sink positioned in the cooling channel and a fan operatively coupled with the motor shaft. Operation of the motor causes rotation of the cooling fan, which draws air through the cooling channel. The air drawn through the cooling channel drawing heat from the heat sink, which cools the motor.

According to another aspect, the housing can also include a front wall including a plurality of inlet openings and a rear wall comprising a plurality of outlet openings. During operation of the meat grinder, air is drawn into the housing through the inlet openings, and discharged through the outlet openings.

According to another aspect, the meat grinder can also include a transfer case that operatively couples the motor and the grinder head. The outer wall of the housing can be sized to extend outward beyond an outward extent of a housing of the transfer case so that air drawn into the cooling channel also causes air to flow over the outside of the transfer case housing. The air flowing over the outside of the transfer ease housing draws heat from the transfer case.

According to another aspect, the heat sink can include a plurality of fins that extend parallel to each other along the length of the cooling channel. The heat sink can be positioned in contact with the motor stator so as to draw heat from the motor stator during operation of the motor.

According to another aspect, the grinder head can also include an auger rotatable to move the raw meat from the inlet toward the outlet, a knife rotatable with the auger to grind the meat moved by the auger, and a fixed hole plate in the outlet through which the ground meat passes. The transfer case can include a housing including an output portion adapted to receive and support the grinder head, a coupling for receiving the auger, and reduction gears adapted to translate rotational force imparted by the motor shaft to rotation of the coupling and the auger.

According to another aspect, the meat grinder can also include a cooling unit attachable to the grinder head to cool the grinder head. Air drawn into the cooling channel can be at least partially cooled by flowing over the cooling unit prior to entering the cooling channel.

### BRIEF DESCRIPTION OF THE DRAWINGS

For a better understanding of the invention, reference may be made to the accompanying drawings.

FIGS. 1-3 are perspective views of a grinder apparatus according to the invention.

FIG. 4 is a top view of the grinder apparatus.

FIG. 5 is a side view of the grinder apparatus.

FIG. 6 is a sectional view of the grinder apparatus taken generally along line 6-6 in FIG. 4.

FIG. 7 is a perspective sectional view of the grinder apparatus taken generally along line 7-7 in FIG. 4.

### DESCRIPTION

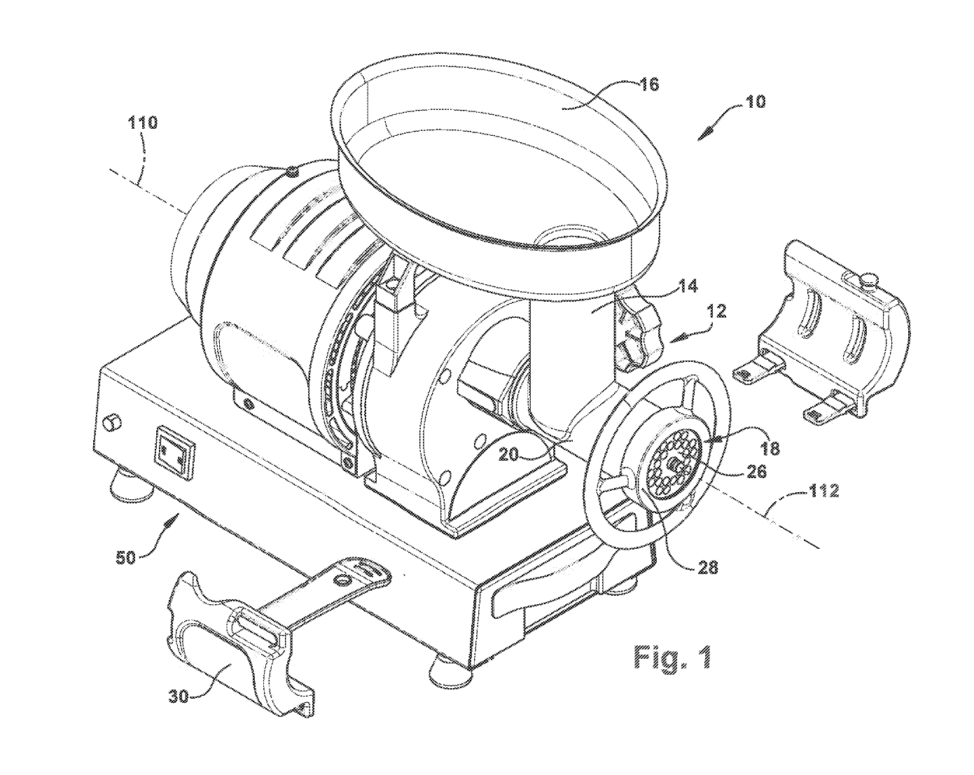

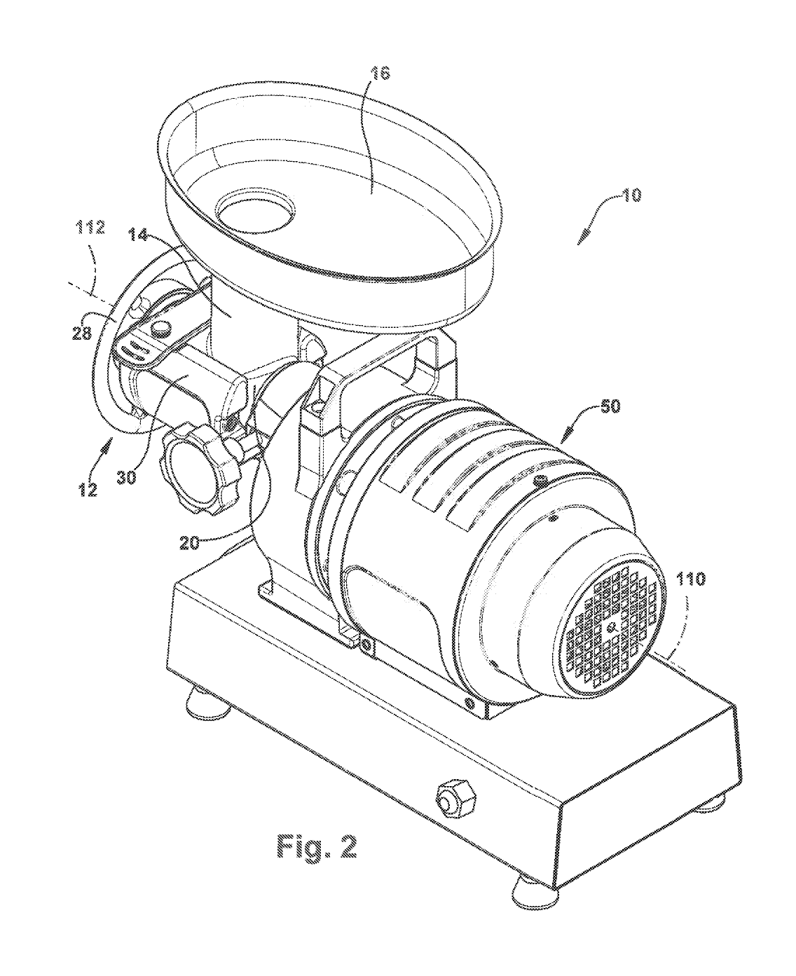

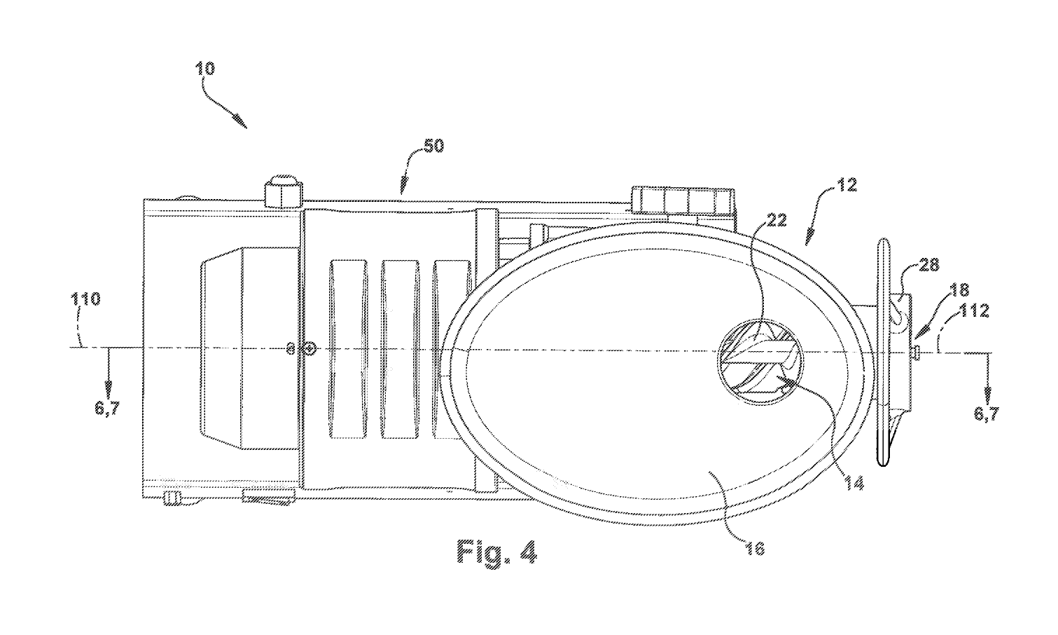

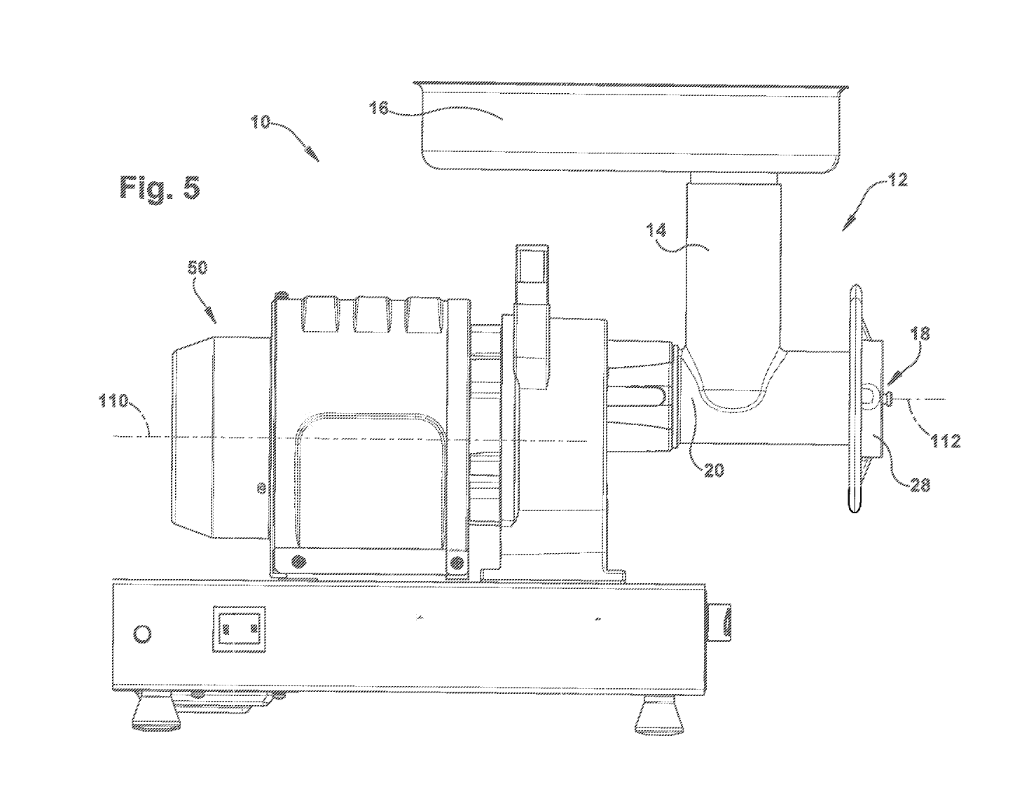

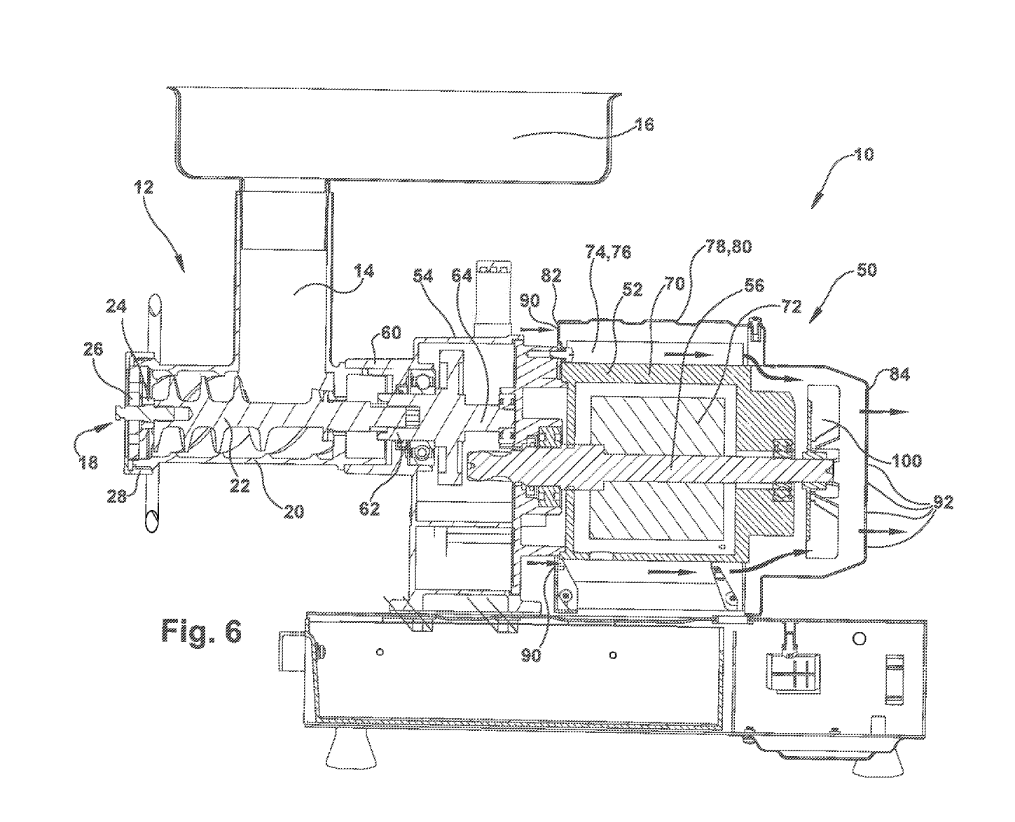

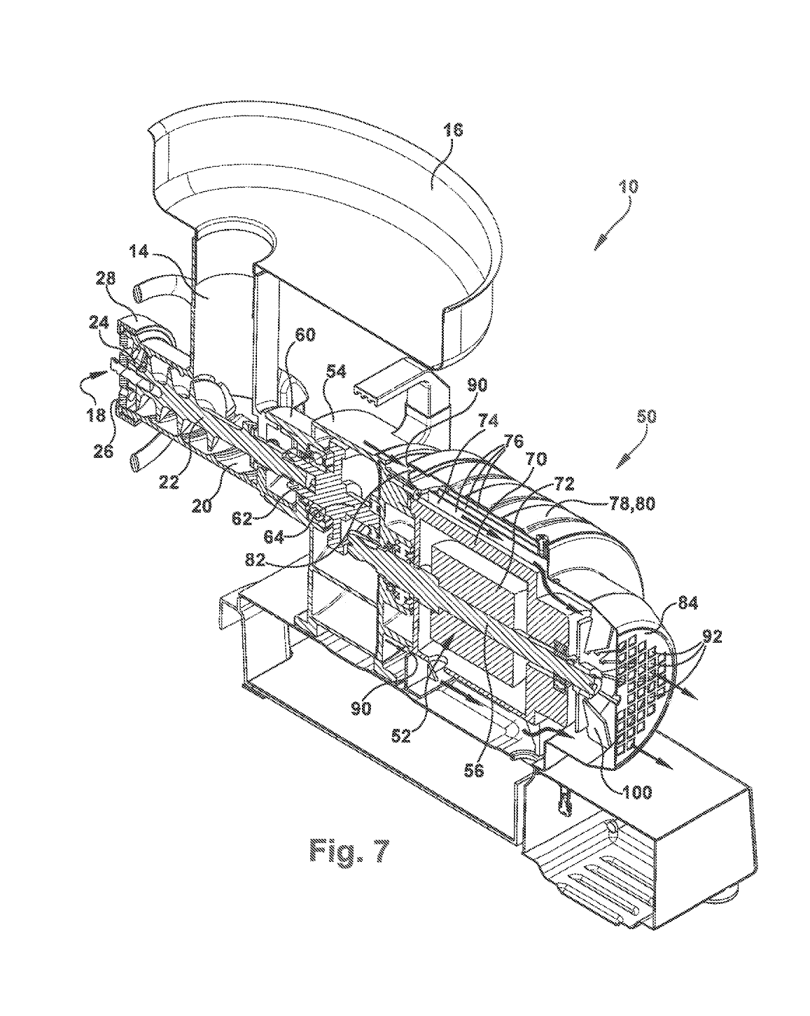

The invention relates to a food processing apparatus in the form of a grinder, particularly a meat grinder. Referring to FIGS. 1-7, a meat grinder 10 includes a grinder head 12 and a drive unit 50, that includes an electric motor 52. The grinder head 12 includes an inlet or chute 14 with an upper tray 16, into which raw meat is fed, and an outlet 18 from which the ground or minced meat is discharged. The grinder head 12 includes a housing 20 that houses typical grinder components, such as an auger/screw conveyor 22, a rotating knife including mincing blades 24, and a fixed hole plate or die 26. These typical components are shown and described in detail, for example, in U.S. Pat. No. 7,207,510 B2, issued Apr. 24, 2007, the disclosure of which is hereby incorporated by reference in its entirety. A threaded collar 28 attaches to the housing 20 to contain the grinder components therein. The collar 28 is removable from the housing for cleaning and for replacing/swapping components.

Whole or cubed raw meat is placed in the tray 16 and fed into the inlet 14 on top of the grinder head 12, and the meat is propelled horizontally on the rotating screw conveyor 22, which rotates about an axis 112, and which can also squash and partially mix the meat as it is propelled. At the end of the screw conveyor 22, the knife 24 is positioned in front of and adjacent to the fixed hole plate 26. The screw conveyor 22 forces the meat past the knife 24 and through the plate 26. The blades of the rotating knife 24 mince or grind the meat, which is discharged through the holes in the plate 26 and through the outlet 18. The size of the holes in the plate helps determine the fineness of the ground meat.

The meat grinder 10 can also include a cooling unit 30 that attaches to the grinder head 12 and helps cool the grinder head to counteract heating due to friction between internal components. This helps prevent the meat from heating up as it is ground, which can cause the ground meat to stick to the grinder components and inhibit or halt the grinding process. The cooling unit 30 can have a variety of configurations. In the illustrated embodiment, the cooling unit 30 utilizes a frozen liquid or gel contained in a housing that conforms to the shape of the grinder housing 20 and attaches to the grinder housing via a strap or other suitable connector. Examples of this and other grinder head cooling features are shown and described in detail in U.S. Patent Application Publication U.S. 2015/0336104 A1, which was published on Nov. 26, 2015, the subject matter of which is hereby incorporated by reference in its entirety.

According to the invention, the drive unit 50 is configured to aid in cooling of the grinder head 12. The ability of the cooling unit 30 is limited in its cooling capacity to that of the frozen coolant material contained therein. Additionally, as soon as use of the meat grinder 10 begins, the cooling unit 30 begins exchanging heat with the grinder head 12. While the cooling unit 30 is effective in cooling the grinder head 12, the laws of thermodynamics apply, and the cooling unit and grinder head move toward a temperature equilibrium. As this occurs, the effectiveness of the cooling unit 30 is lessened until temperature equilibrium is reached, at which point the cooling unit is no longer effective. Therefore, it is desirable to prolong the useful life of the cooling unit 30 to the greatest extent possible.

The drive unit 50 includes cooling features that help the meat grinder 10 to achieve this goal. The drive unit 50 includes a transfer case 54 that is coupled to a motor shaft 56 of the electric motor 52. The transfer case 54 includes a housing 58 that includes an output portion 60. The output portion 60 supports a coupling 62 and reduction gears 64 that operatively connect the motor shaft 56 to the coupling. The reduction gears 64 act as a power transmission that trades speed at the motor shaft 56 with torque at the coupling 62.

The grinder head 12 is connectable with the output portion 60 to support the grinder head on the transfer case 54 of the drive unit 50. When the grinder head 12 is connected to the drive unit 50, the screw conveyor 22 is operatively connected to the coupling 82. In operation of the meat grinder 10, the electric motor 52 rotates its motor shaft 56 about the motor axis 110, which rotates the coupling 62 via the reduction gears 64. The rotating coupling 62 rotates the screw conveyor 22 and mincing blades 24 of the grinder head 12 about the grinder head axis 112.

The electric motor 52 operates at a comparatively high speed or RPMs, which is reduced through the reduction gears 64 in the transfer case 54. Advantageously, the meat grinder takes advantage of the high RPMs motor to provide the meat grinder 10 with enhanced cooling. To this end, the meat grinder 10 includes several structural features that provide this cooling.

The electric motor 52 includes a stator 70 that is electrically excitable to impart rotation to a rotor 72 that is includes and is supported for rotation relative to the stator by the motor shaft 56. The motor 52 also includes a heat sink 74 that at least partially surrounds at least a portion of the stator 70. The heat sink 74 includes a plurality of tins 76 that create surface area for dissipating heat generated by the motor 52. The motor 52 also includes an outer shroud or housing 78 that at least partially surrounds the stator 70, rotor 72, and heat sink 74.

The housing 78 includes a generally cylindrical side wall 80 that extends along the length of the motor 52, a front end wall 82, and a rear end wall 84. The side wall 80 is spaced from the heat sink 74, thereby creating a cooling channel 86 that extends longitudinally along the length of the motor 52. Inlet openings 90 in the front end wall 82 and outlet openings 92 in the rear end wall 84 provide fluid communication between the cooling channel 86 and the environment outside of the motor 52.

The motor 52 also includes a cooling fan 100 at the end of the motor opposite the transfer case 54. The cooling fan 100 is connected to, and rotatable with, the motor shaft 56. The cooling fan 100 is enclosed by the motor housing 78 and is positioned adjacent the outlet openings 92 in the rear end wail 84. The cooling fan 100 includes a plurality of blades 102 that fan out radially from the motor shaft 56.

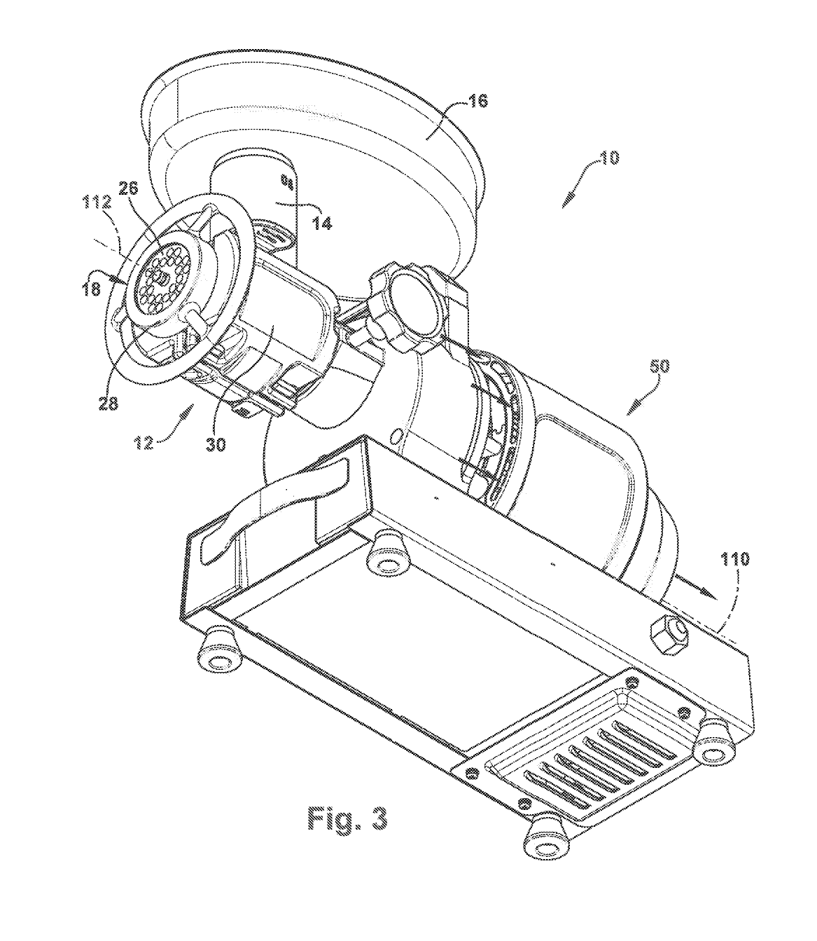

Taking advantage of the comparatively high RPM operation of the motor 52, when the motor runs, the cooling fan creates pressure that drives air out of the outlet openings 92 in the rear end wall 84. The air exiting the housing 78 induces airflow through the cooling channel 86, as indicated by the dark arrows in FIGS. 3, 6, and 7. As a result, operation of the cooling fan 100 draws air into the inlet openings 90 in the front end wall 82. This induced draft of air moves through the cooling channel 86 and exits through the outlet openings in the rear end wall 84. As the air moves through the cooling channel 86, it passes over the fins 76 of the heat sink 74 so that heat is exchanged with the air. As a result the air is heated and the heat sink 74 is cooled. Since the heat sink 74 is heated by operation of the motor 52, its being cooled allows it to remove additional heat from the motor and exchange that heat with the air passing through the cooling channel 86.

According to the invention, the cooling fan 100, heat sink 74, and cooling channel 86 are configured and arranged specifically for a meat grinder implementation. The motor 52 does not require cooling for its operation. The cooling features, i.e., the cooling fan 100, heat sink 74, and cooling channel 86 are designed to draw heat from the motor 52 so that the motor-generated heat does not travel via conduction through the transfer case 54 and into the grinder head 12.

In fact, the cooling fan 100, heat sink 74, and cooling channel 86 are designed to cool the motor 52 to such an extent that it can receive/remove heat from the transfer case 54 and, by extension, receive and remove heat from the grinder head 12. Additionally, the housing 78 is configured so that the dimensions of the side wall 80 are sized to extend outward beyond the outer extent of the transfer case 54. More specifically, in the illustrated embodiment, the cylindrical side wall 80 of the motor housing 78 has a diameter configured to be larger than the diameter of the transfer case 54. In this configuration, the inlet openings 90 in the front end wall 82 are positioned, at least in part, radially outside or beyond the outer extent of the transfer case 54 housing.

As a result, the cooling channel 86 and inlet openings 90 are linearly aligned with the space immediately adjacent the outside wall of the transfer case 54. Because of this, the induced, airflow into the motor housing 52, i.e., the air flow drawn through the inlet openings 90 and into the cooling channel 86, can flow axially, parallel to both the motor and grinder head axes 110, 112, along the outside wall of the transfer case 54 and the grinder head 12. Drawing the air along the transfer case 54 can help to cool the transfer case. Drawing the air along the grinder head 12 can help to cool the grinder head. Additionally, where a cooling unit 30 is fixed to the grinder head 12, the air drawn into the cooling channel can be at least partially cooled by the cooling unit as the air is drawn over its surface. This enhances the cooling effect on the motor, taking advantage of cooling that otherwise would be lost from the cooling unit to the atmosphere surrounding the meat grinder 10.

The oversizing of the cooling fan 100 and cooling channel 86 along with the introduction of the heat sink 74 inside the cooling channel, and coupled with the design that draws air over the grinder head 12, cooling unit 30, and transfer case 54 provides enhanced cooling of both the motor and the transfer case and, by direct and/or indirect extension, the grinder head 12.

The cooling effects provided by the cooling fan 100, cooling channel 86, and heat sink 74 enhance the effectiveness of the cooling pack 30 by removing some of the heat that would otherwise migrate to the grinder head 12 from the motor 52 and/or the transfer case 54. In the specific field of meat grinders, this functionality is especially beneficial due to the fact that meat grinding operation can suffer significant negative effects when the grinder head components and the meat itself is not cold.

While aspects of the present invention have been particularly shown and described with reference to the preferred embodiment above, it will be understood by those of ordinary skill in the art that various additional embodiments may be contemplated without departing from the spirit and scope of the present invention. Other aspects, objects, and advantages of the present invention can be obtained from a study of the drawings, the disclosure, and the appended claims.

Having described the invention, we claim:

1. A meat grinder, comprising:
a motor comprising a stator and a rotor comprising a motor shaft;
a transfer case operatively coupled to the motor shaft; and
a grinder head operatively coupled to the transfer case, the grinder head comprising an inlet into which a raw meat product can be fed and an outlet through which ground meat can be discharged, wherein rotation of the motor shaft imparts operation of the grinder head via the transfer case;
wherein the motor also comprises a housing comprising a generally cylindrical outer wall that is spaced from the stator thereby creating a cooling channel between the stator and the outer wall, the housing further comprising a front wall comprising a plurality of inlet openings and a rear wall comprising a plurality of outlet openings, the motor also comprising a heat sink inside the housing positioned in the cooling channel adjacent the motor stator, the motor further comprising a cooling fan coupled to the motor shaft and positioned adjacent the rear wall;
and wherein during operation of the meat grinder, the motor rotates the cooling fan which discharges air from the housing through the outlet openings, which draws air into the housing through the inlet openings, creating air flow through the cooling channel, the air flow through the channel drawing heat from the heat sink prior to being discharged through the outlet openings.

2. The meat grinder recited in claim 1, wherein the outer wall of the housing is sized to extend outward beyond an outward extent of a housing of the transfer case so that air drawn into the cooling channel also causes air to flow over the outside of the transfer case housing, the air flowing over the outside of the transfer case housing drawing heat from the transfer case.

3. The meat grinder recited in claim 1, wherein the heat sink includes a plurality of fins that extend parallel to each other along the length of the cooling channel.

4. The meat grinder recited in claim 1, wherein the heat sink is positioned in contact with the motor stator so as to draw heat from the motor stator during operation of the motor.

5. The meat grinder recited in claim 1, wherein the grinder head further comprises an auger rotatable to move the raw meat from the inlet toward the outlet, a knife rotatable with the auger to grind the meat moved by the auger, and a fixed hole plate in the outlet through which the ground meat passes.

6. The meat grinder recited in claim 5, wherein the transfer case comprises a housing including an output portion adapted to receive and support the grinder head, a coupling for receiving the auger, and reduction gears adapted to translate rotational force imparted by the motor shaft to rotation of the coupling and the auger.

7. The meat grinder recited in claim 1, further comprising a cooling unit attachable to the grinder head to cool the grinder head, wherein the air drawn into the cooling channel is at least partially cooled by flowing over the cooling unit prior to entering the cooling channel.

8. A meat grinder, comprising:
a grinder head comprising an inlet into which a raw meat product can be fed and an outlet through which ground meat can be discharged; and
a motor comprising a stator and a rotor comprising a motor shaft, the grinder head being operatively coupled to the motor shaft such that rotation of the motor rotor imparts grinding operation of the grinder head;
wherein the motor also comprises a housing comprising a generally cylindrical outer wall that is spaced from the stator thereby creating a cooling channel between the stator and the outer wall, the motor also comprising a heat sink positioned in the cooling channel and a fan operatively coupled with the motor shaft so that motor operation causes rotation of the cooling fan, which draws air through the cooling channel, the air drawn through the cooling channel drawing heat from the heat sink, which cools the motor.

9. The meat grinder recited in claim 8, wherein the housing further comprises a front wall comprising a plurality of inlet openings and a rear wall comprising a plurality of outlet openings, and wherein during operation of the meat grinder, air is drawn into the housing through the inlet openings, and discharged through the outlet openings.

10. The meat grinder recited in claim 8, further comprising a transfer case that operatively couples the motor and the grinder head, wherein the outer wall of the housing is sized to extend outward beyond an outward extent of a housing of the transfer case so that air drawn into the cooling channel also causes air to flow over the outside of the transfer case housing, the air flowing over the outside of the transfer case housing drawing heat from the transfer case.

11. The meat grinder recited in claim 8, wherein the heat sink includes a plurality of fins that extend parallel to each other along the length of the cooling channel.

12. The moat grinder recited in claim 8, wherein the heat sink is positioned in contact with the motor stator so as to draw heat from the motor stator during operation of the motor.

13. The meat grinder recited in claim 8, wherein the grinder head further comprises an auger rotatable to move the raw meat from the inlet toward the outlet, a knife rotatable with the auger to grind the meat moved by the auger, and a fixed hole plate in the outlet through which the ground meat passes.

14. The meat grinder recited in claim 13, wherein the transfer case comprises a housing including an output portion adapted to receive and support the grinder head, a coupling for receiving the auger, and reduction gears adapted to translate rotational force imparted by the motor shaft to rotation of the coupling and the auger.

15. The moat grinder recited in claim 8, further comprising a cooling unit attachable to the grinder head to cool the grinder head, wherein the air drawn into the cooling channel is at least partially cooled by flowing over the cooling unit prior to entering the cooling channel.
